(19) United States
(12) Patent Application Publication
(10) Pub. No.: US 2007/0276642 A1
(43) Pub. Date: Nov. 29, 2007

(54) Process For Producing A High-Frequency Equivalent Circuit Diagram For Electronic Components

(75) Inventor: Zoltan Huszka, Budapest (HU)

Correspondence Address: FISH & RICHARDSON PC, P.O. BOX 1022, MINNEAPOLIS, MN, 55440-1022, US

(73) Assignee: AUSTRIAMICROSYSTEMS AG, Unterpremstatten (AT)

(21) Appl. No.: 11/579,216

(22) PCT Filed: Apr. 29, 2005
(86) PCT No.: PCT/EP05/04671

§ 371 Date: Jul. 27, 2007

(30) Foreign Application Priority Data
Apr. 30, 2004 (DE) 10 2004 021 421.2

(51) Int. Cl. G06F 17/50

(52) U.S. Cl. 703/14

(57) ABSTRACT

A method for providing a high-frequency equivalent circuit for an electronic component includes performing a high-frequency measurement on the electronic component, where the electronic component is modeled as a two-port circuit network, obtaining impedance (Z) parameters or admittance (Y) parameters of the electronic component based on the high-frequency measurement, determining branch impedances of a T-equivalent circuit or a Pi-equivalent circuit that corresponds to the electronic component, where determining branch impedances is performed with reference to the Z parameters or the Y parameters, determining coefficients of fractional rational functions for use in describing the branch impedances, determining equivalent circuits as a function of the fractional rational functions, where the equivalent circuits correspond to the branch impedances, and assembling the equivalent circuits to produce a high-frequency equivalent circuit of corresponding to the electronic component.

### TECHNICAL FIELD

This application relates to a method for providing a high-frequency equivalent circuit for an electronic component.

### BACKGROUND

It is known that passive components, such as resistors, capacitors, and inductors, which are fabricated in integrated circuit technology, are frequency dependent. The frequency dependency must be known precisely in order to design high-frequency switching circuits like those used, for example, in wireless communications.

Here, it is desirable to describe the behavior of such components, especially their frequency dependency, preferably with an equivalent circuit. Measurements for characterizing the properties of electronic components are normally performed with network analyzers, for example, with so-called VNA, Voltage Network Analyzers. This method determines the S-parameters of a two-port network of the passive component. The S-parameters are typically represented in a scattering matrix.

Currently, heuristic methods are used to reconstruct the unknown switching circuit of the equivalent circuit. Such a method is disclosed, for example, in the document D. Cheung et al.: “Monolithic Transformers for Silicon RFIC Design,” Proceedings of the 1998 Bipolar/BiCMOS Circuits and Technology Meeting, 1998. The corresponding, commercially available software for performing such methods allows circuits to be entered by the user for testing. Here, it is assumed that optimizing the elements of the hypothetical equivalent circuit via successive approximation solves the problem. The assumption of being able to successively approximate the solution, however, is incorrect in theory. Each individual, successive activity requires a modification of the analyzed circuit. Currently available tools, however, give absolutely no feedback for this refinement, apart from the printout of the result. Because a clear method leading to the goal of obtaining the equivalent circuit is not disclosed, success is left up to the imagination, the experience, and the luck of the engineer. If the number of reactances exceeds two or three, the known methods normally fail.

Indeed, in the case of simple switching circuit components, such as resistors, capacitors, and inductors, some help can be provided by the designer of the integrated circuit layers and by process parameter information for the corresponding integrated fabrication technology. It is problematic, however, at frequencies in and above the gigahertz range, that the frequency-dependent material constants and the electromagnetic couplings and interactions deviate significantly from the textbook circuits.

Similar problems arise in the attempt to characterize an IC package, that is, a non-housed integrated circuit, in which the material combination and the complex geometry make the development of suitable circuits impossible. The described problems also arise for structures for evaluating electrostatic discharge, ESD, and so-called dummy structures.

### SUMMARY

Described herein is a method for providing a high-frequency equivalent circuit for electronic components, which allows a high-frequency equivalent circuit to be obtained starting from a measurement of circuit parameters. The method includes the following:

providing Z-parameters or Y-parameters of an electronic component,

determining branch impedances with reference to the Z-parameters or the Y-parameters,

determining coefficients of a fractional-rational function for describing the branch impedance,

determining an equivalent circuit as a function of the fractional-rational function, and

assembling the equivalent circuits of the branch impedances into a high-frequency equivalent circuit of the electronic component.

According to the proposed principle, Z-parameters or Y-parameters of an electronic component are provided. These parameters may be derived from a high-frequency measurement of the electronic component.

Then a decomposition into branch impedances is performed with reference to the Z or Y parameters.

Next, for each of these branch impedances, the coefficients of a fractional-rational function for describing the related branch impedance are determined. The fractional-rational function can have a previously known structure, as explained in more detail below.

Then an electric equivalent circuit is determined, in turn, for each of the determined fractional-rational functions.

The individual equivalent circuits, which thus each represent a branch impedance, are finally reassembled into the high-frequency equivalent circuit of the electronic component.

The branch impedances may be determined with reference to a T equivalent circuit or with reference to a Π (pi) equivalent circuit of the electronic component. The selection for whether a T equivalent circuit or a Π equivalent circuit is used is performed as a function of whether Z-parameters or Y-parameters are provided.

The equivalent circuit of the branch impedances is assembled analogously according to a T or Π equivalent circuit.

The numerator order and the denominator order of the predefined fractional-rational function may be given such that the corresponding numerator and denominator orders, which can also be different, are predetermined and an error estimate is performed for each order. The fractional-rational function with the numerator order and denominator order that give the lowest error is selected.

The equivalent circuits are determined as a function of the fractional-rational functions, e.g., such that successive poles and/or zeros are extracted from the complex, fractional-rational function, as explained in more detail below. In this way, at each extracted pole and/or zero, a corresponding inductance and/or capacitance is added into the equivalent circuit. Simple limit estimates also allow the determination of whether it involves a series element or a parallel element. Resistances can also be extracted in this way from the fractional-rational function and added to the equivalent circuit.

Advantageously, the Z-parameters or Y-parameters are obtained in that an electrical high-frequency measurement on the electronic component is performed at first, with which the S-parameters of the electronic component are determined.

Subsequently, the determined S-parameters may be converted into Z or Y parameters according to known conversion rules.

The electronic component is advantageously represented as a two-port network and the high-frequency measurement is performed on this component. In this way, the S-parameters are determined with reference to a 2×2 scattering matrix.

The electronic component, whose high-frequency equivalent circuit is provided, may be a passive electronic component.

Alternatively or additionally, the electronic component can include or represent an integrated switching circuit.

Likewise, the high-frequency equivalent circuit of a package of an integrated switching circuit, a so-called IC package, may be obtained with the present method.

Some or all of the method may be executed with a calculating unit.

Some or all of the method may be executed automatically by a computer.

Determining the S-parameters of the electronic component is performed by an automatic execution of the high-frequency measurements, e.g., with a network analyzer. The S-parameters obtained in this way can be further processed advantageously automatically by a computer according to the proposed principle.

The described method may be coded in a machine-readable code.

The machine-readable code may be stored on a data carrier.

A deterministic method for synthesizing high-frequency equivalent circuits of electronic components, such as passive electronic components, is proposed. Here, the principle is based on obtaining the network function or the generator function of the component from measured data, initially with reference to the fractional-rational function, instead of constructing and simulating test circuits. The classes of allowed functions are strictly determined by the network theory. For preferred, step-by-step increase of the network function order, whose structure is known a priori, the calculated error goes through a minimum relative to the measurements. This minimum identifies the network function that is suitable for representing the equivalent circuit. The equivalent circuit can be realized by network synthesis.

Two-port networks comprising only resistors, capacitors, and inductors have reciprocal properties. Other two-port networks, such as insulators or directional couplers of microwave technology are not reciprocal and also contain gyrators in addition to the components named above. Passive components belong to the category of two-port networks named first.

Such two-port networks can be characterized advantageously by only three independent impedances or admittances.

To obtain the equivalent circuit more quickly, it is possible to execute determining the coefficients of a fractional-rational function for describing the branch impedance and determining an equivalent circuit as a function of the fractional-rational function for each branch impedance each simultaneously and thus in parallel processing.

Determining the equivalent circuits as a function of the appropriate fractional-rational function in the scope of network synthesis can be performed automatically. Here, the following method can be applied, for example.

First, the base components or primary function blocks of the network synthesis are defined in the form of one-part networks:

Resistors, inductors, and capacitors each as discrete components can be found as so-called one-port networks.

A parallel oscillating circuit comprises a parallel switch of an inductor and a capacitor. It is characterized by an infinite impedance at a resonance frequency.

A series oscillating circuit has a series circuit of an inductor with a capacitor. Its impedance is zero at its resonance frequency.

A so-called Brune complex is a component with two connections. A first connection is connected to a first connection of the primary winding of an ideal transformer. A second connection of the primary winding is connected to a first connection of a secondary winding. A resistor and a capacitor are connected to a second connection of the Brune complex. The free connection of the resistor is connected to a second connection of the secondary winding, while the free connection of the capacitor is connected to the common connection of the primary and secondary windings. The impedance of the Brune complex is finite, both at a zero frequency and also at an infinite frequency. In other words, a pure reactance is formed at these frequencies.

The one-port networks named above, including the Brune complex, are also designated as primary one-port networks.

Another one-port network is designated as a conductor. It comprises a chain of the primary one-port networks listed above, which connects a first and a second node of the conductor to each other in the form of transfer branches. The common nodes of the successive transfer branches are connected to the second node of the conductor by additional, primary one-port networks in the form of shunt branches.

The synthesis of the one-port network or, in other words, the equivalent circuit with two connections is performed from the fractional-rational network function in the form of a conductor one-port network, as explained below with reference to a preferred procedure.

The poles of the network function correspond to the poles of the transfer branches. Here, a pole at zero frequency or at infinite frequency corresponds to a capacitor or an inductor in the shunt branch. Each of these components is added to the end of the conductor as a single one-port network in the form of a transfer branch. By extracting this element in the factor decomposition of the fractional-rational function, its order is reduced by one. The impedance defined by the remaining network function terminates the conductor one-port network. Another decomposition is performed in the subsequent actions.

One pole with finite frequency can be only a double pole, because imaginary poles are conjugate pairs on the imaginary axis. Such double poles correspond to a parallel oscillating circuit at the end of the conductor one-port network as a transfer branch. Extracting this pole pair reduces the order of the network function by two. The impedance defined by the remaining network function terminates the conductor one-port network. Another decomposition is performed in the subsequent actions.

Zeros of the fractional-rational network function correspond to zeros of the shunt branches of the conductor one-port network. A zero at infinite or zero frequency corresponds to a capacitor or an inductor of a shunt branch. Each of these elements is added to the end of the conductor one-port network as a single shunt branch. Extracting this term from the network function reduces its order by one. The impedance defined by the remaining network function terminates the conductor one-port network. Another decomposition is performed in the subsequent actions.

A zero at finite frequency can be only a double root, because imaginary zeros are conjugate pairs on the imaginary axis. Such a double root corresponds to a series oscillating circuit, which is added to the end of the conductor one-port network in the form of a shunt branch. Factoring out this double root from the network function reduces its order by two. The impedance defined by the remaining network function terminates the conductor one-port network. Another decomposition is performed in the subsequent activities.

If the numerator and the denominator of the fractional-rational network function are of equal order, the real part has a non-negative minimum at a finite frequency. This minimum resistance is added to the end of the conductor one-port network as a resistor in the form of a transfer branch. Ignoring the resistance component from the network function leaves its order either unchanged or reduces the order by one. The impedance defined by the remaining network function terminates the conductor one-port network. Another decomposition is performed in the subsequent actions.

If the above action has been performed, and the orders of the numerator and denominator polynomials of the network function nevertheless remain equal, then the real part of the network function is zero at a finite frequency. In other words, here there is a pure reactance. In this case, the described Brune complex is added to the end of the conductor one-port network in the form of a transfer branch. Leaving out the Brune complex from the network function reduces its order by two. The impedance defined by the remaining network function terminates the conductor one-port network. Another decomposition is performed in the subsequent actions.

The actions above for synthesizing the one-port network or, in other words, the equivalent circuit with two connections are repeated until the fractional-rational network function disappears.

### DESCRIPTION OF THE DRAWINGS

FIG. 1, a T equivalent circuit of a two-port network;

FIG. 2, a Π equivalent circuit of a two-port network,

FIG. 3, an example error estimate of numerator and denominator order of an example, fractional-rational function,

FIG. 4a, a Smith chart,

FIG. 4b, the pole-zero diagram associated with FIG. 4a for a first activity of an example network synthesis,

FIG. 5, an equivalent circuit of a first activity of a network system on the example,

FIG. 6a, a Smith chart,

FIG. 6b, a pole-zero diagram on FIG. 6a for a second activity of the synthesis of the equivalent circuit of the example,

FIG. 7, the equivalent circuit after the second activity of the example network synthesis,

FIG. 8a, a Smith chart,

FIG. 8b, the associated pole-zero arrangement,

FIG. 9, the equivalent circuit to an example third activity of the network synthesis,

FIG. 10a, as an example, a Smith chart and

FIG. 10b, as an example, a pole-zero arrangement to a fourth activity of an example network synthesis,

FIG. 11, the equivalent circuit after the fourth activity,

FIG. 12a, a Smith chart and

FIG. 12b, the associated pole-zero arrangement to an example fifth activity of a network synthesis,

FIG. 13, the equivalent circuit after the fifth activity of the network synthesis,

FIG. 14a, a Smith chart to a sixth activity,

FIG. 14b, the associated pole-zero diagram and

FIG. 15, the equivalent circuit after the sixth activity of the example network synthesis,

FIG. 16a, a Smith chart,

FIG. 16b, a pole-zero arrangement and

FIG. 17, the associated equivalent circuit after the last activity of the network synthesis as an example,

FIG. 18, the high-frequency equivalent circuit of a spiral inductor as an example,

FIGS. 19a-19d, example diagrams of an example user interface for a computer implementation of the method,

FIGS. 20a-20d, a comparison, in which a network function of a different order was intentionally selected,

FIG. 21, an example signal flow chart according to the proposed principle.

### DETAILED DESCRIPTION

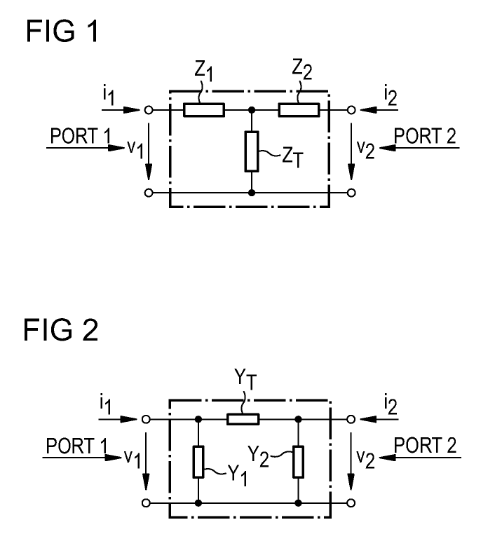

FIG. 1 shows the T equivalent circuit of a two-port network. The branch impedances of the T equivalent circuit of the two-port network can be obtained from the matrix of the Z-parameters of the two-port system according to the following:

$$\begin{matrix}{Z}_{T} = \frac{1}{2} ( {z}_{12} + {z}_{21} ) \\ {Z}_{1} = {z}_{11} - {Z}_{T} \\ {Z}_{2} = {z}_{22} - {Z}_{T} .\end{matrix}$$

Here, Z₁ designates the first series impedance, Z₂ designates the second series impedance, and Z_{T} designates the shunt impedance. z11, z12, z21, and z22 are the four elements of the 2×2 Z-parameter matrix of the two-port network.

FIG. 2 shows the Π (Pi) equivalent circuit network of a two-port network with a series admittance Y_{T} and two shunt admittances Y₁ and Y₂. The branch admittances are calculated from the Y-parameter matrix according to the following:

$$\begin{matrix}{Y}_{T} = \frac{1}{2} ( {y}_{12} + {y}_{21} ) \\ {Y}_{1} = {y}_{11} - {Y}_{T} \\ {Y}_{2} = {y}_{22} - {Y}_{T}\end{matrix}$$

In both cases, it is possible to reduce the determination of the high-frequency equivalent circuit of the two-port network to the determination of three equivalent circuits for one-port networks, namely for the three branch impedances or for the three branch admittances. Use is currently made of this property.

Below, starting from branch impedances, initially a suitable network function is derived according to predetermined activities, and then an example equivalent circuit is synthesized. This is in no way restrictive, however, because the reciprocal values of the branch admittances produce impedances, for example. Therefore, a completely equivalent process on the basis of admittances can be performed.

Initially, the best-suited network function, namely a fractional-rational function, is determined, which at best corresponds to the branch impedance to be described.

According to network theory, the impedance of a concentrated, invariant, passive, linear one-port network can be expressed as a rational function of two polynomials as a function of the complex frequency s=jω according to

$$Z ( s ) = \frac{{A}_{m} ( s )}{{B}_{n} ( s )} = \frac{{a}_{0} + {a}_{1} s + … + {a}_{m} {s}^{m}}{{b}_{0} + {b}_{1} s + … + {b}_{n} {s}^{n}} .$$

For a valid network function, strict initial conditions C1-C6 that are summarized below apply:

C1: all coefficients are real and have the same sign.

C2: the difference of the orders of the numerator and denominator equals at most 1.

C3: Z(s) may not have any poles and zeros in the right half plane.

C4: poles on the imaginary axis have multiplicity 1 with positive residues.

C5: the real part of the impedance is non-negative at all frequencies.

C6: the poles and zeros are either simple real roots or conjugate complex pole pairs.

Condition C4 is equivalent to the appearance of an ideal, parallel LC resonator at a realizable impedance. Because lossless LC resonator pairs cannot be fabricated, purely imaginary poles do not appear in integrated circuits. A single pole can be present at the origin, however, and represents a series capacitor. If one introduces the notation Z_{k,n} for the impedance, where n is the denominator order and (n+k) is the numerator order, then the conditions C1 and C2 allow only three different forms for Z(s), namely

$${Z}_{- 1 , n} ( s ) = \frac{1 + {a}_{1} s + … + {a}_{n - 1} {s}^{n - 1}}{{b}_{0} + {b}_{1} s + … + {b}_{n} {s}^{n}} ; n = 1 , 2 , …$$

$${Z}_{0 , n} ( s ) = \frac{1 + {a}_{1} s + … + {a}_{n} {s}^{n}}{{b}_{0} + {b}_{1} s + … + {b}_{n} {s}^{n}} ; n = 0 , 1 , …$$

$${Z}_{1 , n} ( s ) = \frac{1 + {a}_{1} s + … + {a}_{n + 1} {s}^{n + 1}}{{b}_{0} + {b}_{1} s + … + {b}_{n} {s}^{n}} ; n = 1 , 2 , …$$

At ω=0, the impedance may not be zero, because otherwise the passive component would have to be created with a series resistance of zero. Division by a₀ leads to a normalized first term in the numerator. Because the impedance of a passive component in a realistic circuit cannot become infinitely large with increasing frequency, the third notation Z_{1,n} can be neglected. The case n=0 for Z_{0,n} can be omitted due to its triviality.

Thus, the actually possible, fractional-rational functions according to the proposed principle are reduced to the quantities according to the following Table 1.

TABLE 1
k

| n | −1 | 0 | 1 |
|---|---|---|---|
| 0 | | | |
| 1 | $\frac{1}{{b}_{0} + {b}_{1} s}$ | $\frac{1 + {a}_{1} s}{{b}_{0} + {b}_{1} s}$ | |
| 2 | $\frac{1 + {a}_{1} s}{{b}_{0} + {b}_{1} s + {b}_{2} {s}^{2}}$ | $\frac{1 + {a}_{1} s + {a}_{2} {s}^{2}}{{b}_{0} + {b}_{1} s + {b}_{2} {s}^{2}}$ | |
| — | — | — | |
| N | $\frac{1 + {a}_{1} s + … {a}_{N - 1} {s}^{N - 1}}{{b}_{0} + {b}_{1} s + … {b}_{N} {s}^{N}}$ | $\frac{1 + {a}_{1} s + … {a}_{N} {s}^{N}}{{b}_{0} + {b}_{1} s + … {b}_{N} {s}^{N}}$ | |

According to this setting of the set of possible, predetermined fractional-rational functions, the numerator and denominator orders, as well as the coefficients, can be determined. For this purpose, measurement data of the real component are used, as explained in more detail below.

If one designates the complex vector of the measurement data with Ψ(s), then one can write, in general form,

$$\frac{I + {a}_{1} s + … {a}_{n + k} {s}^{n + k}}{{b}_{0} + {b}_{1} s + … {b}_{n} {s}^{n}} = Ψ ( s )$$

$${a}_{1} s + … {a}_{n + k} {s}^{n + k} - {b}_{0} Ψ ( s ) - {b}_{1} s Ψ ( s ) - … - {b}_{n} {s}^{n} Ψ ( s ) = - 1$$

The complex frequency s is normalized to a real, positive angular frequency Ω according to

$$p = \frac{s}{Ω} ; {a}_{i}^{*} = {a}_{i} {Ω}^{t} ; {b}_{i}^{*} = {b}_{i} {Ω}^{t} ; l = 0 , 1 , 2 , … ,$$

If one introduces
frᵢ^{(m)}=Re(pᵢ^{m}); frᵢ^{(m)}=Im(pᵣ^{m}); Fₜ^{(m)}=pᵢ^{m}Ψ(pᵢ); Frᵢ^{(m)}=Re(Fᵢ^{(m)}); Fiᵢ^{(m)}=Im(Fᵢ^{(m)})
then the unknown coefficients a₁*, . . . , a*ₙ₊ₖ, b₀*, . . . , bₙ* can be determined from the measurement data at m different measurement frequencies by solving the following sets of linear equations:

$$[ \begin{matrix}{fr}_{1}^{( 1 )} … {fr}_{1}^{( n + k )} - {Fr}_{1}^{( 0 )} … - {Fr}_{1}^{( n )} \\ {fr}_{2}^{( 1 )} … {fr}_{2}^{( n + k )} - {Fr}_{2}^{( 0 )} … - {Fr}_{2}^{( n )} \\ ⋮ \\ {fr}_{m}^{( 1 )} … {fr}_{m}^{( n + k )} - {Fr}_{m}^{( n )} … - {Fr}_{m}^{( n )} \\ {fi}_{1}^{( 1 )} … {fi}_{1}^{( n + k )} - {Fi}_{1}^{( 0 )} … - {Fi}_{1}^{( n )} \\ {fi}_{2}^{( 1 )} … {fi}_{2}^{( n + k )} - {Fi}_{2}^{( 0 )} … - {Fi}_{2}^{( n )} \\ ⋮ \\ {fi}_{m}^{( 1 )} … {fi}_{m}^{( n + k )} - {Fi}_{m}^{( n )} … - {Fi}_{m}^{( n )}\end{matrix} ] \cdot [ \begin{matrix}{a}_{1}^{*} \\ ⋮ \\ {a}_{n + k}^{*} \\ {b}_{0}^{*} \\ ⋮ \\ {b}_{n}^{*}\end{matrix} ] = [ \begin{matrix}- 1 \\ - 1 \\ ⋮ \\ - 1 \\ 0 \\ 0 \\ ⋮ \\ 0\end{matrix} ]$$

Due to the condition C1, these coefficients are limited to the set of non-negative real numbers.

Below, an error estimate for determining the optimum numerator and denominator orders is performed.

If one compares the estimated network functions with the actual measurements, then the resulting errors can be represented advantageously in table form.

TABLE 2

| | k | | |
|---|---|---|---|
| n | 1 | 0 | 1 |
| 0 | | | |
| 1 | R_{-1,1} | R_{0,1} | |
| 2 | R_{-1,2} | R_{0,2} | |
| : | : | : | |
| N | R_{-1,N} | R_{0,N} | |
| : | : | : | |

The errors are shown as a function of the numerator order n in two columns. The column according to Table 2 with the lower error is selected. Furthermore, the value N is selected, at which the error is either at a minimum or at least no longer significantly decreases with increasing order.

Therefore, the numerator order and denominator order of the fractional-rational function are set unambiguously.

The fractional-rational network function, which best represents the measurement result of the respective branch impedance, is set accordingly through optimization in terms of numerator order, denominator order, and all of the coefficients in a way leading to the goal. The success of this setting is independent of the experience of the user.

In connection with these preliminary considerations of a rather theoretical nature, now the synthesis of an equivalent circuit will be described with reference to an embodiment.

The measurement data for an example impedance Z are obtained, such that initially an electric measurement is performed on the real component with determination of the S parameters. Then the Z parameters are determined from the S parameters and these are broken down into branch impedances. As an example, the following set of data for the impedance Z is recorded:

Frequency [Hz]

| | | |
|---|---|---|
| 6.0000e+006 | 1.2511e+002 | −2.8503e+004i |
| 6.9084e+006 | 1.2511e+002 | −2.4755e+004i |
| 7.9543e+006 | 1.2511e+002 | −2.1500e+004i |
| 9.1585e+006 | 1.2511e+002 | −1.8673e+004i |
| 1.0545e+007 | 1.2511e+002 | −1.6218e+004i |
| 1.2142e+007 | 1.2511e+002 | −1.4085e+004i |
| 1.3980e+007 | 1.2511e+002 | −1.2266e+004i |
| 1.6096e+007 | 1.2511e+002 | −1.0624e+004i |
| 1.8533e+007 | 1.2511e+002 | −9.2270e+003i |
| 2.1339e+007 | 1.2511e+002 | −8.0135e+003i |
| 2.4569e+007 | 1.2511e+002 | −6.9596e+003i |
| 2.8289e+007 | 1.2512e+002 | −6.0441e+003i |
| 3.2572e+007 | 1.2512e+002 | −5.2490e+003i |
| 3.7503e+007 | 1.2512e+002 | −4.5584e+003i |
| 4.3181e+007 | 1.2512e+002 | −3.9586e+003i |
| 4.9719e+007 | 1.2513e+002 | −3.4375e+003i |
| 5.7246e+007 | 1.2513e+002 | −2.9849e+003i |
| 6.5912e+007 | 1.2514e+002 | −2.5917e+003i |
| 7.5891e+007 | 1.2515e+002 | −2.2500e+003i |
| 8.7381e+007 | 1.2516e+002 | −1.9532e+003i |
| 1.0061e+008 | 1.2518e+002 | −1.6952e+003i |
| 1.1584e+008 | 1.2520e+002 | −1.4710e+003i |
| 1.3338e+008 | 1.2523e+002 | −1.2761e+003i |
| 1.5357e+008 | 1.2526e+002 | −1.1066e+003i |
| 1.7682e+008 | 1.2531e+002 | −9.5910e+002i |
| 2.0359e+008 | 1.2538e+002 | −8.3070e+002i |
| 2.3442e+008 | 1.2547e+002 | −7.1883e+002i |
| 2.6991e+008 | 1.2559e+002 | −6.2127e+002i |
| 3.1077e+008 | 1.2575e+002 | −5.3607e+002i |
| 3.5782e+008 | 1.2596e+002 | −4.6154e+002i |
| 4.1199e+008 | 1.2625e+002 | −3.9617e+002i |
| 4.7436e+008 | 1.2664e+002 | −3.3857e+002i |
| 5.4618e+008 | 1.2717e+002 | −2.8789e+002i |
| 6.2887e+008 | 1.2798e+002 | −2.4280e+002i |
| 7.2408e+008 | 1.2891e+002 | −2.0249e+002i |
| 8.3370e+008 | 1.3031e+002 | −1.6614e+002i |
| 9.5992e+008 | 1.3228e+002 | −1.3302e+002i |
| 1.1052e+009 | 1.3506e+002 | −1.0247e+002i |
| 1.2726e+009 | 1.3902e+002 | −7.3944e+001i |
| 1.4652e+009 | 1.4466e+002 | −4.7011e+001i |
| 1.6871e+009 | 1.5267e+002 | −2.1461e+001i |
| 1.9425e+009 | 1.6389e+002 | +2.5736e+000i |
| 2.2366e+009 | 1.7923e+002 | +2.4435e+001i |
| 2.5752e+009 | 1.9946e+002 | +4.2753e+001i |
| 2.9650e+009 | 2.2468e+002 | +5.5379e+001i |
| 3.4139e+009 | 2.5377e+002 | +5.9660e+001i |
| 3.9308e+009 | 2.8386e+002 | +5.3232e+001i |
| 4.5259e+009 | 3.1048e+002 | +3.5263e+001i |
| 5.2111e+009 | 3.2873e+002 | +7.5205e+000i |
| 6.0000e+009 | 3.3506e+002 | −2.5636e+001i |

According to the method described above, a network function is given with the denominator order 4 and numerator order 4, that is, n=4 and k=0 with the structure

$$Z ( s ) = \frac{a 0 + a 1 * s + a 2 * {s}^{⋀} 2 + a 3 * {s}^{⋀} 3 + a 4 * {s}^{⋀} 4}{b 0 + b 1 * s + b 2 * {s}^{⋀} 2 + b 3 * {s}^{⋀} 3 + b 4 * {s}^{⋀} 4}$$

and the coefficients

| | |
|---|---|
| a0 | 1.0000e+000 |
| a1 | 2.1279e−010 |
| a2 | 2.1223e−020 |
| a3 | 9.1729e−031 |
| a4 | 4.1753e−042 |
| b0 | 0.0000e−000 |
| b1 | 9.3062e−013 |
| b2 | 8.9672e−023 |
| b3 | 3.0200e−033 |
| b4 | 3.7269e−044 |

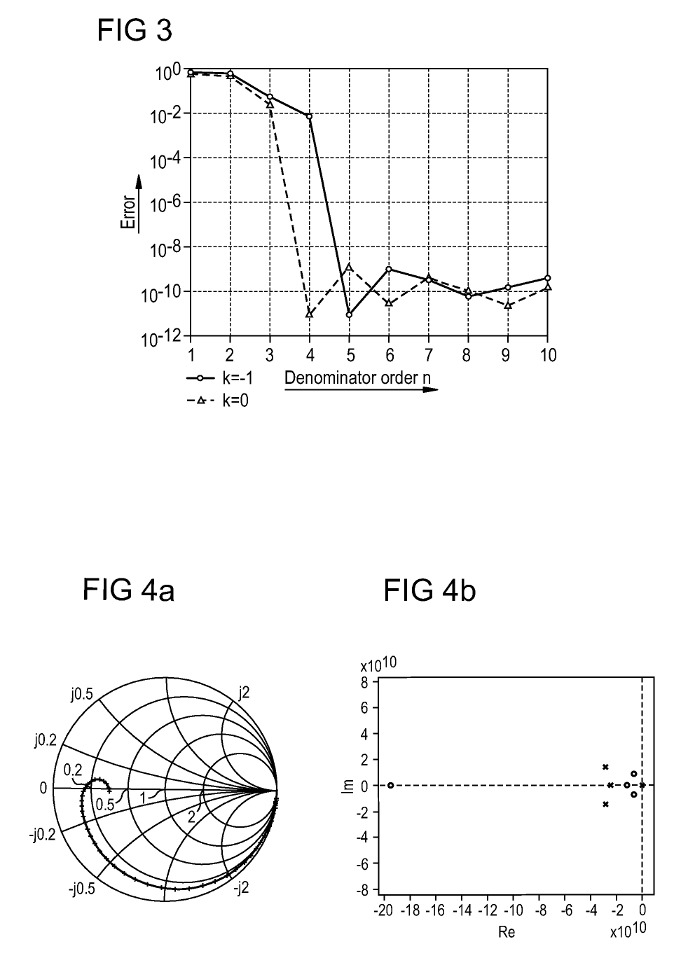

The associated error estimate is shown in FIG. 3 as a function of the numerator and denominator orders for determining the numerator and denominator orders.

A Smith chart and a pole-zero arrangement as figures accompany each activity of the following example network synthesis starting from the determined, fractional-rational function.

The example, fractional-rational function has a pole at the origin. This is recognized immediately with reference to the coefficient b0=0 in the denominator. This pole of the impedance is removed from the origin. The pole corresponds to a series capacitance with the value C₁=b₁=9.3062 e-13 F. This can be removed from the equation according to the following specification

$$Z 1 ( s ) - Z ( s ) - \frac{1}{{b}_{1} s} ,$$

so that the following remains:

$${Z}_{1} ( s ) = \frac{a 0 + a 1 * s + a 2 * s \hat{} 2 + a 3 * s \hat{} 3}{b 0 + b 1 * s + b 2 * s \hat{} 2 + b 3 * s \hat{} 3}$$

with n=3 and k=0 and with the coefficients:

| | |
|---|---|
| a0 | 1.0000e+000 |
| a1 | 1.5441e−010 |
| a2 | 7.5345e−021 |
| a3 | 3.5861e−032 |
| b0 | 7.9929e−003 |
| b1 | 7.7018e−013 |
| b2 | 2.5938e−023 |
| b3 | 3.2018e−034 |

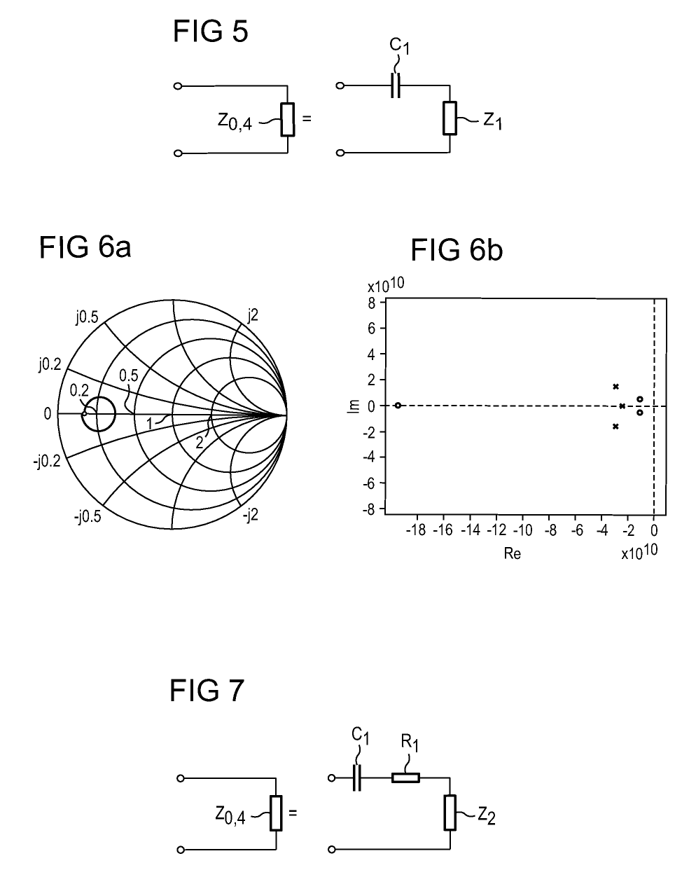

FIG. 5 shows the extracted part of the equivalent circuit. FIGS. 6a and 6b describe the remaining network function.

Through boundary crossing at infinite frequencies, a resistance R1=112.03Ω is given. With the specification Z₂(s)=Z₁(s)−R₁, the following is given for the remaining function with n=3 and k=−1:

$${Z}_{2} ( s ) = \frac{a 0 + a 1 * s + a 2 * s \hat{} 2}{b 0 + b 1 * s + b 2 * s \hat{} 2 + b 3 * s \hat{} 3}$$

with the coefficients:

| | |
|---|---|
| a0 | 1.0000e+000 |
| a1 | 6.5169e−010 |
| a2 | 4.4280e−020 |
| b0 | 7.6466e−002 |
| b1 | 7.3680e−012 |
| b2 | 2.4814e−022 |
| b3 | 3.0622e−033 |

The correspondingly expanded equivalent circuit is shown in FIG. 7;

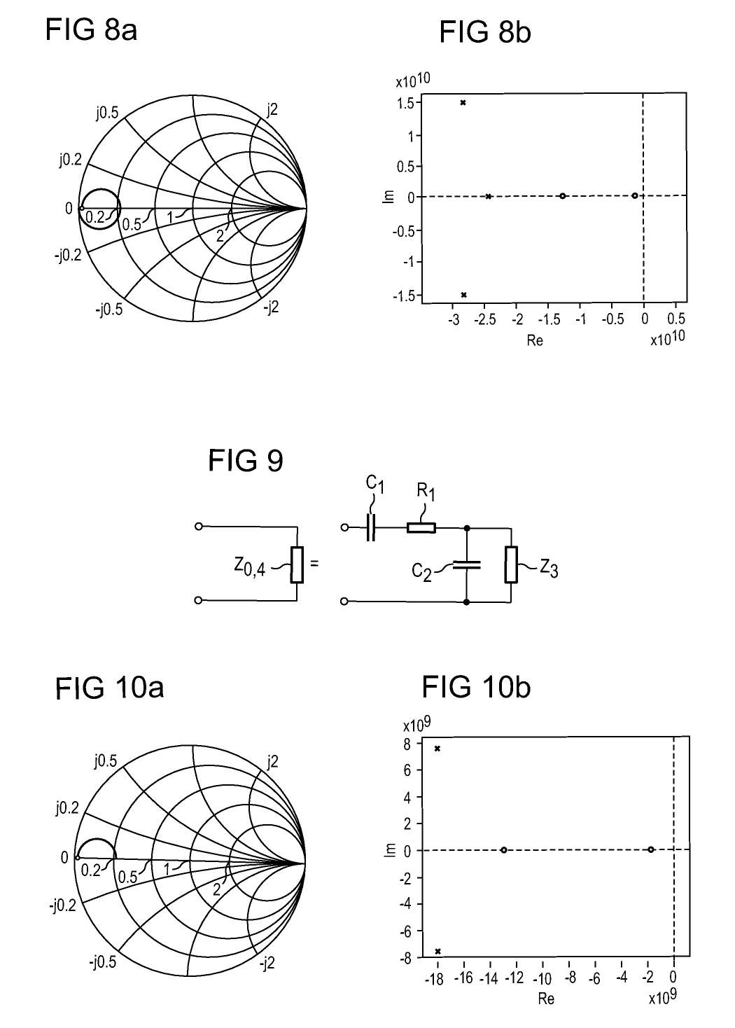

FIGS. 8a and 8b describe the remaining network function.

Then a zero of the impedance at the boundary crossing towards infinity is removed. This corresponds to a parallel capacitance

$${C}_{2} = \frac{{b}_{3}}{{a}_{2}} = 6.9155 e - 14 F , \\ where$$

$${Y}_{2} ( s ) = {Y}_{2} ( s ) - \frac{{b}_{3}}{{a}_{2}} s .$$

It follows for the remaining, fractional-rational function with n=2 and k=0:

$${Z}_{3} ( s ) = \frac{a 0 + a 1 * s + a 2 * s \hat{} 2}{b 0 + b 1 * s + b 2 * s \hat{} 2}$$

with the coefficients

| | |
|---|---|
| a0 | 1.0000e+000 |
| a1 | 6.5169e−010 |
| a2 | 4.4280e−020 |
| b0 | 7.6466e−002 |
| b1 | 7.2989e−012 |
| b2 | 2.0307e−022 |

The already correspondingly expanded, synthesized equivalent circuit is given in FIG. 9.

FIGS. 10a and 10b describe the remaining network function.

By crossing the border at the 0 frequency, a resistance R2=13.078Ω to be removed was found. This resistance is extracted according to the specification
Z₄(s)=Z₃(s)−R₂
so that the fractional-rational function according to n=2, k=0 remains:

$${Z}_{4} ( s ) = \frac{a 0 + a 1 * s + a 2 * s \hat{} 2}{b 0 + b 1 * s + b 2 * s \hat{} 2}$$

with the coefficients
a0 0.0000e+000
a1 5.5624a−010
a2 4.1624e−020
b0 7.6466e−002
b1 7.2989e−012
b2 2.0307e−022

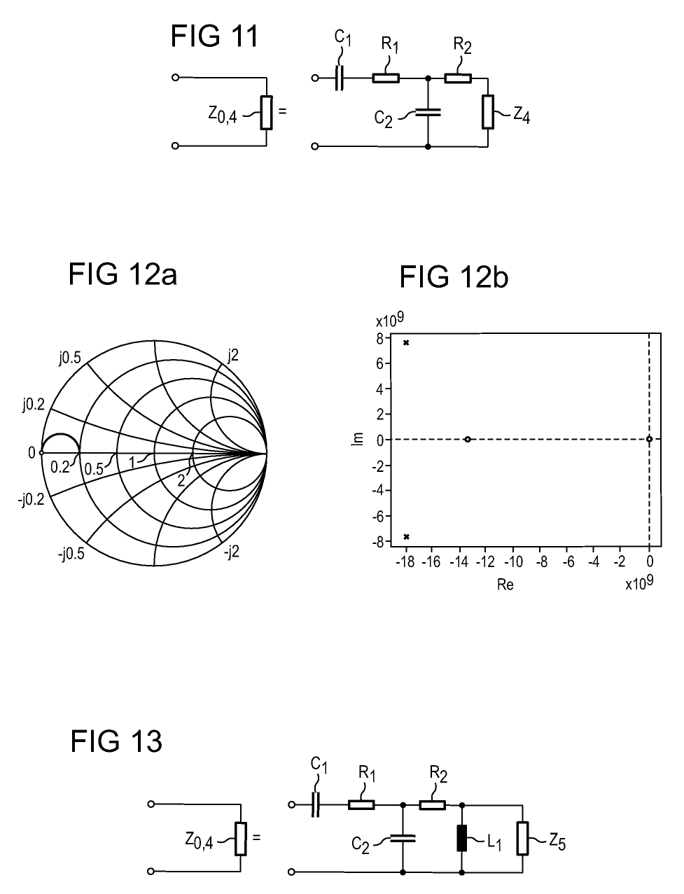

The equivalent circuit expanded by this resistance R2 is indicated in FIG. 11.

FIGS. 12a and 12b describe the remaining network function.

Below, an impedance zero at the origin is removed. This corresponds to a parallel inductor in admittance representation.

$${L}_{1} = \frac{{a}_{1}}{{b}_{0}} = 7.2743 e - 9 H , \\ where$$

$${Y}_{5} ( s ) = {Y}_{4} ( s ) - {sL}_{1}$$

With n=1 and k=0, the function remains

$${Z}_{5} ( s ) = \frac{a 0 + a 1 * s}{b 0 + b 1 * s}$$

with the coefficients

| | |
|---|---|
| a0 | 1.0000e+000 |
| a1 | 7.4832e−011 |
| b0 | 2.8348e−003 |
| b1 | 3.6508e−0013 |

The equivalent circuit expanded by this inductor L1 is shown in FIG. 13.

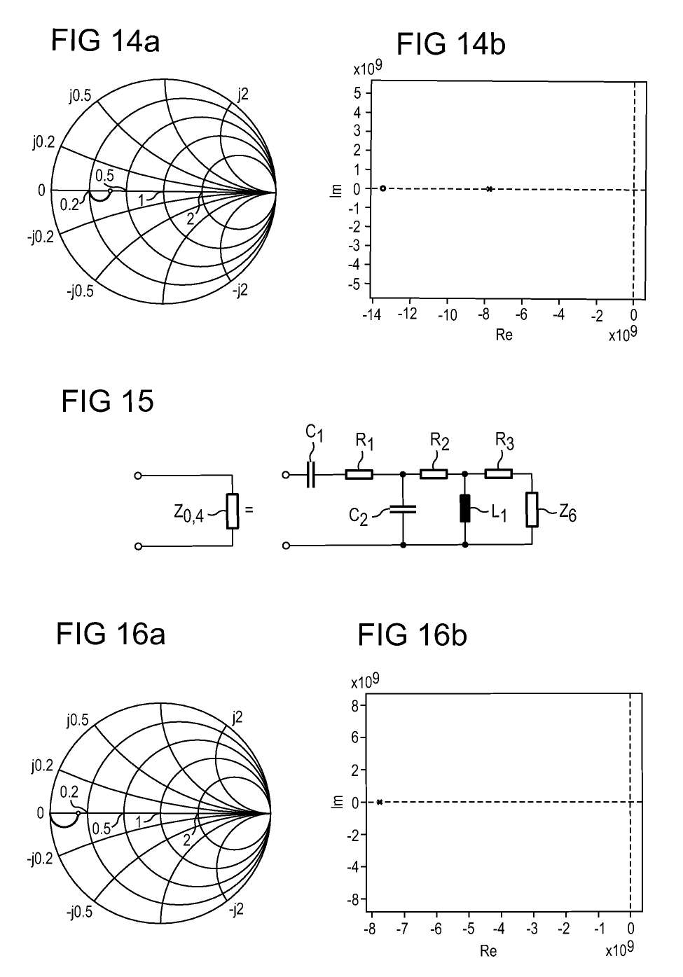

FIGS. 14a and 14b describe the remaining, fractional-rational network function.

Below, a resistor at infinite frequency is again to be removed. The resistance R3 is given by

$${R}_{3} = \frac{{a}_{1}}{{b}_{1}} = 204.97 Ohm$$

and leaves
Z₆(s)=Z₃(s)−R₃
with n=1 and k=−1, thus

$${Z}_{6} ( s ) = \frac{a 0}{b 0 + b 1 * s}$$

with the coefficients

| | |
|---|---|
| a0 | 1.0000e+000 |
| b0 | 6.7664e−003 |
| b1 | 8.7142e−013 |

The equivalent circuit expanded by the resistance R3 is shown in FIG. 15.

FIGS. 16a and 16b describe the remaining network function.

This is the end of the synthesis of the equivalent circuit of the branch impedance, because Z₆(s) is the canonical form of a parallel RC circuit with the components R4 and C3.

$$\begin{matrix}a 0 & 1.0000 e + 000 \\ b 0 & 6.7664 e - 003 \\ b 1 & 8.7142 e - 013\end{matrix}$$

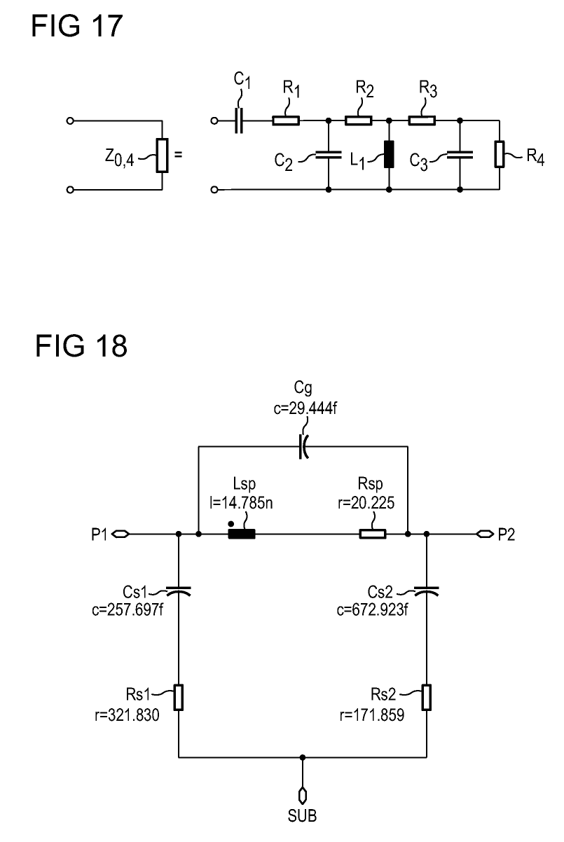

FIG. 17 shows the final equivalent circuit of the branch impedance of the present example.

The input impedance of the equivalent circuit according to FIG. 17 agrees with the network function used as an origin within machine accuracy. The synthesized equivalent circuit of FIG. 17 actually corresponds to the branch impedance Z₁₁ of the two-port network of FIG. 18.

FIG. 18 describes an example model of a spiral inductor. Because the synthesis problem has not only a single solution, why the structures and coefficient values are different is to be explained. Using this simple embodiment, it becomes especially clear that the heuristic methods described above would have no chance of success for such an order of not even especially higher complexity.

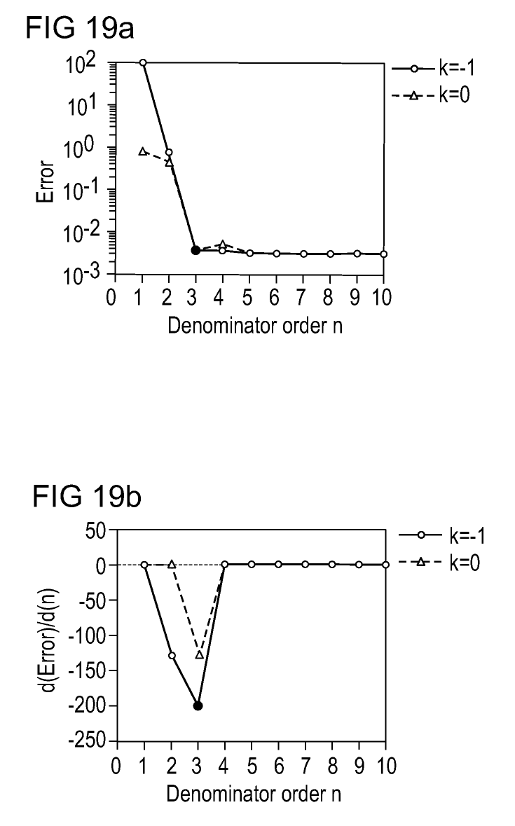

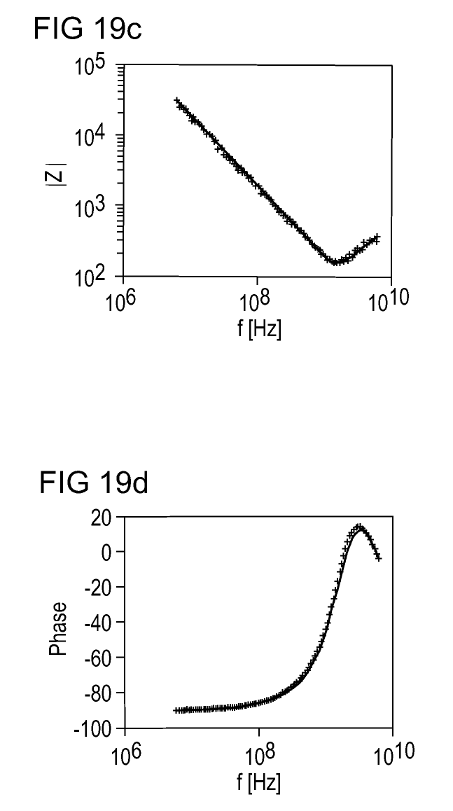

FIGS. 19a to 19d show diagrams for additional embodiments. Here, the method was implemented according to the present principle in machine-readable code.

FIG. 19a shows the relevant error of the network function to be determined relative to the measurement data as a function of numerator order n and difference between numerator and denominator orders k.

FIG. 19b shows the associated gradients with respect to FIG. 19a.

The thick point in FIGS. 19a and 19b corresponds to the automatic selection of the machine code for the theoretically optimum network function in this special measurement according to the error estimate and minimization.

FIG. 19c shows the amplitude and FIG. 19d shows the associated phase of each of the measured and simulated data points according to the selection from FIGS. 19a and b. One clearly sees the high degree of agreement of the simulation and measurement.

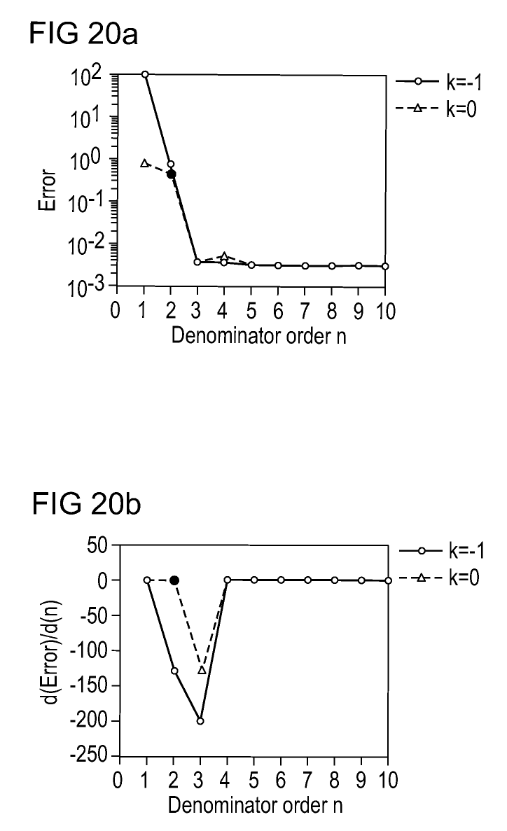

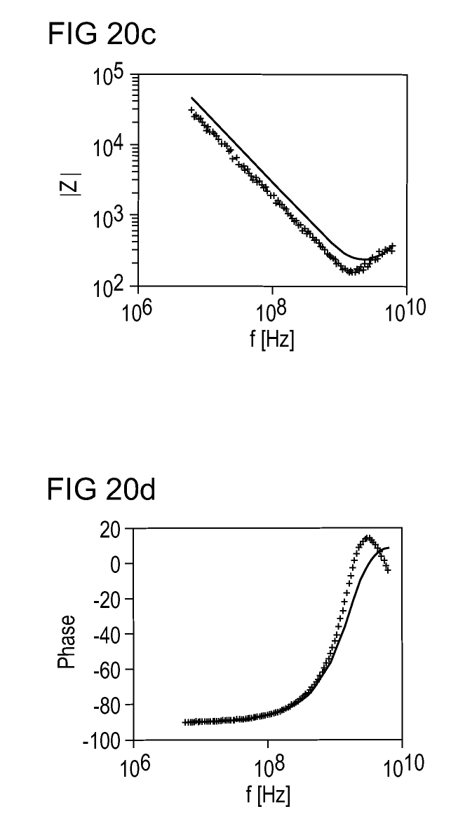

For comparison, FIGS. 20a-20d, which largely correspond to those of FIGS. 19a-19d, show the results for a different determination of the order of the denominator order relative to that, which is optimum based on the determined, smallest error. Thus, in FIGS. 20a-20d, an order that is too small relative to the determined error was intentionally selected for the fractional-rational network function. One recognizes that the agreement of the equivalent circuit with the measurement data is clearly less than for the network function that is optimum according to the proposed principle according to FIGS. 19a-19d.

Below, a so-called Netlist, which is output by the machine code, is shown as an example. With this netlist, an electronic equivalent circuit can be generated with any arbitrary, known network simulator tool for describing the behavior of the passive components.

| | | | |
|---|---|---|---|
| C1 | 1 | 2 | 8.9173e−013 |
| C2 | 2 | 0 | 3.9914e−014 |
| R1 | 2 | 3 | 1.1745e−002 |
| L1 | 3 | 0 | 8.3065e−009 |
| R2 | 3 | 0 | 2.9259e+002 |

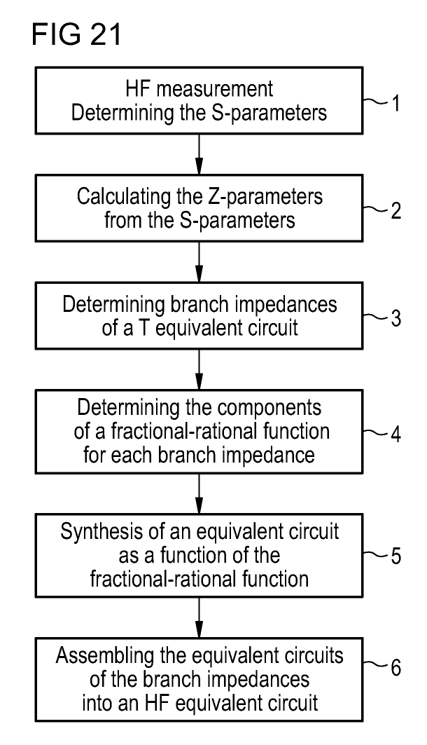

For better clarity of the proposed method, FIG. 21 shows an example flow chart of individual activities in an example summary.

In a first activity 1, a high-frequency measurement is performed on the component, whose high-frequency properties are to be described by an electrical high-frequency equivalent circuit. This measurement is performed with a network analyzer. In this way, the S-parameters of the component are determined.

In a subsequent activity 2, the Z-parameters of the component are calculated as a function of the S-parameters. Alternatively, the Y-parameters could also be calculated, for example.

The Z-parameter representation allows the determination of related branch impedances of a T equivalent circuit in a simple way from the Z-parameters in a third activity 3.

For each of these branch impedances, the coefficients of a fractional-rational function are determined, which describes the related branch impedance.

In this way, initially the numerator order and the denominator order of the fractional-rational function are determined. Here, valid initial conditions are taken into consideration. The numerator and denominator orders are set such that for each allowed combination of numerator and denominator order, an error estimate of the related fractional-rational function is performed.

The coefficients of the fractional-rational function are each determined by solving a linear system of equations as a function of the measurement data.

Because the fractional-rational function, including numerator order, denominator order, and its coefficients can be determined independently for each branch impedance, activity 4 can be executed simultaneously for each branch impedance.

In a subsequent activity 5, a high-frequency equivalent circuit is determined by network synthesis for each determined, fractional-rational function, thus for each branch impedance. In this way, in an iterative process, individual components, such as inductors, capacitors, and resistors are extracted and the equivalent circuit is assembled little by little.

The activity of synthesis 5 can also be executed independently for each branch impedance and thus in a parallel process.

Finally, in a last activity 6, all of the equivalent circuits obtained by synthesis for the branch impedances are combined to form a common high-frequency equivalent circuit. This is performed as a function of the T equivalent circuit selected in activity 3.

In contrast to heuristic methods, the proposed method is not directed to the experience of the user in order to produce a realizable and precise result for a high-frequency model of the examined component. Instead, the method based on the predetermined activities for implementation in machine-readable code and/or higher programming languages is suitable, so that according to the proposed method, especially for passive components, a high-precision high-frequency model can be provided, whose properties precisely describe the real component up to the gigahertz range.

In particular, for the proposed method, no experimentally input circuits are analyzed, but instead the best fitting network function is constructed for the branch impedance to be modeled.

The method can also be executed from the basis of an admittance viewpoint instead of an impedance viewpoint.

The network synthesis can also be performed in other ways, starting from the determined, fractional-rational function.

1-19. (canceled)

20. A method for providing a high-frequency equivalent circuit for an electronic component, comprising:
performing a high-frequency measurement on the electronic component, the electronic component being modeled as a two-port circuit network;
obtaining impedance (Z) parameters or admittance (Y) parameters of the electronic component based on the high-frequency measurements;
determining branch impedances of a T-equivalent circuit or a Pi-equivalent circuit that corresponds to the electronic component, wherein determining branch impedances is performed with reference to the Z parameters or the Y parameters;
determining coefficients of fractional rational functions for use in describing the branch impedances;
determining equivalent circuits as a function of the fractional rational functions, the equivalent circuits corresponding to the branch impedances; and
assembling the equivalent circuits to produce a high-frequency equivalent circuit corresponding to the electronic component.

21. The method of claim 20, further comprising:
determining S parameters of the electronic component as a function of the high-frequency measurement; and
calculating the Z parameters or the Y parameters using the S parameters.

22. The method of claim 20, further comprising:
determining numerator order and denominator order of a function rational function via an error estimate of each allowable numerator and denominator order by estimating error associated with predefined and denominator orders; and
selecting numerator and denominator orders which produce least error.

23. The method of claim 20, wherein the coefficients of the fractional rational functions are determined from a set of real numbers; and
wherein all coefficients have a same sign.

24. The method of claim 20, further comprising:
determining numerator order and denominator order of a fractional rational function such that the numerator order differs from the denominator order by one, at most.

25. The method of claim, 20 further comprising:
determining coefficients of a fractional rational function such that the fractional rational function has no poles and no zeros in a right half plane.

26. The method of claim 20, further comprising:
determining coefficients of fractional rational such that a positive residue, if present, is allocated to each pole on an imaginary axis.

27. The method of claim 20, further comprising:
determining coefficients of a fractional rational such that a real part of an impedance represented by the fractional rational function is non-negative for all frequencies.

28. The method of claim 20, further comprising:
determining coefficients of a fractional rational function such that poles and zeros of the fractional rational function are either conjugate complex pole pairs or simple real roots.

29. The method of claim 20, further comprising:
determining an equivalent circuit as a function of a fractional rational via successive extraction of poles and/or zeros of the fractional rational function and adding an inductor or capacitor corresponding to each pole and/or zero to the equivalent circuit.

30. The method of claim 21, further comprising:
determining the S parameters using a 2×2 scattering matrix.

31. The method of claim 20, wherein the high frequency equivalent circuit is for a passive electronic component.

32. The method of claim 20, wherein the high-frequency equivalent circuit is for an integrated circuit.

33. The method of claim 20, wherein the high-frequency equivalent circuit is for an IC package.

34. The method of claim 20, wherein at least part of the method is performed via a calculating unit.

35. The method of claim 20, wherein at least part of the method is performed via a computer programmed to automatically determine the high-frequency equivalent circuit.

36. The method of claim 21, wherein the S parameters are determined by high-frequency measurement performed automatically using a network analyzer.
